(19) United States
(12) Patent Application Publication
(10) Pub. No.: US 2005/0205533 A1
(43) Pub. Date: Sep. 22, 2005

(54) Laser processing machine and laser processing method

(76) Inventor: Helmut Reis, Leonberg (DE)

Correspondence Address: FISH & RICHARDSON PC, P.O. BOX 1022, MINNEAPOLIS, MN, 55440-1022, US

(21) Appl. No.: 11/007,587

(22) Filed: Dec. 9, 2004

(30) Foreign Application Priority Data
Dec. 10, 2003 (EP) 03028338

(51) Int. Cl. B23K 26/20; B23K 26/03

(52) U.S. Cl. 219/121.63; 219/121.83

(57) ABSTRACT

A laser processing machine adapted for joining two metal workpieces includes a laser processing head and two workpiece holders. The workpiece holders hold the workpieces in contact with each other and cause relative motion between the workpieces to generate frictional heat to preheat the surfaces of the workpieces to be joined with energy directed from the laser processing head.

### CLAIM OF PRIORITY

This application claims priority under 35 USC § 119 to European Patent Application Serial No. 03028338, filed on Dec. 10, 2003, the entire contents of which are hereby incorporated by reference.

### TECHNICAL FIELD

This invention relates to materials processing and, more particularly, to a laser processing machine and a laser processing method.

### BACKGROUND

German Patent Serial No. DE 196 37 465 C1 discloses a method for laser welding of hardenable steel.

During thermal treatment (e.g., through laser welding) of hardenable steel having increased carbon content (e.g., greater than about 0.2%), ferrite and pearlite are converted into an allotropic form of an iron-carbon structure called austenite. Austenite has the property that it dissolves the overall free carbon in metal. When the heated steel is cooled slowly, the austenite is reconverted into ferrite and pearlite. If cooling is performed rapidly, the carbon that was initially easily dissolved in austenite, cannot diffuse out of the lattice during the fast cooling process and is forced to remain dissolved in the face-centered cubic lattice, causing a tetragonal distortion of the lattice. This tetragonal distortion generates a high inner structural tension in the joining seam of the steel that was heat treated. This form of iron-carbon structure is called martensite.

It is known that, at the end of the cooling phase, austenite is converted into martensite, and this conversion is accompanied by a volume change that can cause cracks in the metal when the cooling is performed too quickly. To prevent the formation of cracks, several methods have been developed. During slow cooling of heat treated steel in a cooling bath, the steel can be removed from the cooling bath when it reaches the temperature at which martensite starts to form, and the steel can be subsequently further cooled by air. For tempering the martensitic structure, the steel can be removed from the cooling bath when it reaches the temperature at which martensite begins to form, and the steel can then be introduced into a bath having the same temperature until the inside of the steel reaches this temperature. Subsequently, the steel can be cooled in the air throughout the martensite forming temperature range. For most steel types, this the martensite forming temperature range extends from approximately 288° C. to room temperature. For austenitic tempering, the steel can be introduced into a bath of metal or salt that is maintained at a constant temperature at which the structure of the steel is changed as desired, and the steel can be maintained in such a bath until the conversion is completed.

To prevent the above-mentioned formation of cracks in the region of a weld joint, German Patent Serial No. DE 196 37 465 C1 proposes briefly preheating of the workpiece using a defined parameter set (e.g., time, temperature etc.). The temporary thermal treatment may be performed with induction heating to heat the workpiece in the region of the joint. The preheating of the workpiece reduces the cooling rate of the workpiece at the weld joint.

### SUMMARY

In a first general aspect, a laser processing machine adapted for joining two metal workpieces includes a laser processing head and two workpiece holders. The workpiece holders hold the workpieces in contact with each other and cause relative motion between the workpieces to generate frictional heat to preheat the surfaces of the workpieces to be joined with energy directed from the laser processing head.

Implementations can include one or more of the following features. For example, the laser processing head can be adapted and arranged for welding the two workpieces together. The laser processing machine can further include a sensor adapted and arranged for detecting the temperature of the workpieces in the region of a welding seam. The metal workpieces include hardenable steel.

In another general aspect, a method of preparing two metal workpieces to be joined includes holding the workpieces in holders, bringing surfaces of the workpieces to be joined into contact with each other, and causing relative motion of the workpieces to each other in to generate frictional heat at the surfaces to preheat the surfaces.

Implementations can include one or more of the following features. For example, the method can further include monitoring the temperature of the surfaces. The method can further include heating the surfaces to a controlled desired temperature with the generated frictional heat. The method can further include synchronously moving the workpieces at a speed that is suitable for a laser welding process. The method can further include welding the workpieces together with a laser beam.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic side view of parts of a laser processing machine for joining two workpieces.

### DETAILED DESCRIPTION

As disclosed herein, a laser processing machine having a simple construction that provides the possibility of preheating the workpiece. For example, in a laser processing machine adapted for joining two workpieces (in particular, hardenable steel workpieces) can include a laser processing head, workpiece holders, and a device for moving the workpieces relative to each other while the workpieces are in contact to generate frictional heat to preheat the surfaces of the workpieces to be joined. Using frictional heat to preheat the work pieces obviates the need for expensive means for heating the joining surfaces. Furthermore, preheating the workpieces by using only existing machine components (e.g., the workpiece holders) allows the construction of the laser processing machine to be relatively simple and inexpensive.

Thus, the workpiece holders of the laser processing machine are used to produce heat through friction. The surfaces of the workpieces to be joined are preheated by a rotary motion of at least one of the two joining partners, while the other joining partner remains at rest or is rotated in the opposite direction, to generate frictional heat. The surfaces to be joined are heated to a controlled desired temperature by, and the workpieces are synchronously brought to a speed which is suitable for the welding process, and the workpieces are subsequently welded using the laser beam.

The surfaces of the workpieces to be joined are heated only up to the required preheating temperature, and a sensor can be used to sense and control the temperature of the surfaces to be joined. During friction welding, the components are pressed against each other using clamping devices and are turned such that the components are heated to the welding temperature due to friction. The welded workpieces generally have a bead produced through compression of the clamping devices that can be removed only through extensive refinishing.

The frictional heating permits homogeneous heating of the joining surfaces, such that deformations produced during friction welding do not occur.

The use of frictional preheating can be used for steel or material combinations having a similar hardening behavior during cooling, where preheating of the workpieces before laser processing is advisable (e.g., components for the construction of drives for automotive vehicles).

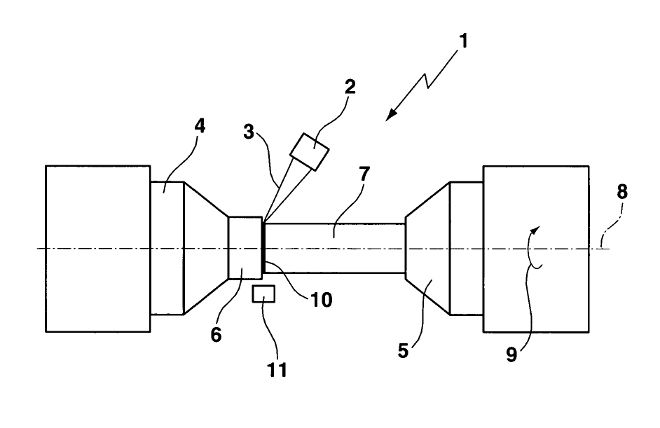

As shown in FIG. 1, a laser processing machine 1 includes, in addition to further machine parts that are not shown, a laser processing head 2 for producing a laser beam 3 and two workpiece holders 4 and 5.

The workpieces 6 and 7 to be joined, which are made of hardenable carbon-containing steel, are held in workpiece holders 4 and 5 formed by a clamping chuck. The workpiece 6 is rotated about a longitudinal axis 8 (see arrow 9) and urged against the workpiece 7, which is either at rest or which rotates in the opposite direction. The generated frictional heat heats a joining location 10. When the target temperature, detected by a sensor 11, has been reached, both workpieces 6 and 7 are synchronously brought to a speed that is suitable for the welding process, and are subsequently welded using the laser beam 3.

The heat introduced to the joining location 10 before joining prevents excessively fast cooling of the welding seam such that the formation of martensite and associated resulting tensions in the welding seam are reduced.

A number of embodiments of the invention have been described. Nevertheless, it will be understood that various modifications may be made. Accordingly, other embodiments are within the scope of the following claims.

1. A laser processing machine adapted for joining two metal workpieces, the machine comprising:
a laser processing head; and
two workpiece holders, wherein the workpiece holders hold the workpieces in contact with each other and cause relative motion between the workpieces to generate frictional heat to preheat the surfaces of the workpieces to be joined with energy directed from the laser processing head.

2. The laser processing machine of claim 1, wherein the laser processing head is adapted and arranged for welding the two workpieces together.

3. The laser processing machine of claim 1, further comprising a sensor adapted and arranged for detecting the temperature of the workpieces in the region of a welding seam.

4. The laser processing machine of claim 1, wherein the metal workpieces comprise hardenable steel.

5. A method of preparing two metal workpieces to be joined, the method comprising:
holding the workpieces in holders;
bringing surfaces of the workpieces to be joined into contact with each other; and
causing relative motion of the workpieces to each other in to generate frictional heat at the surfaces to preheat the surfaces.

6. The method of claim 5, further comprising monitoring the temperature of the surfaces.

7. The method of claim 6, further comprising heating the surfaces to a controlled desired temperature with the generated frictional heat.

8. The method of claim 7, further comprising synchronously moving the workpieces at a speed that is suitable for a laser welding process.

9. The method of claim 7, further comprising welding the workpieces together with a laser beam.
